(19) United States
(12) Patent Application Publication
(10) Pub. No.: US 2023/0158701 A1
(43) Pub. Date: May 25, 2023

(54) Electrode Cutting Device and Method and Electrode Manufacturing Apparatus Comprising the Same

(71) Applicant: LG Energy Solution, Ltd., Seoul (KR)

(72) Inventors: Sung Chul Park, Daejeon (KR); Sang Wook Kim, Daejeon (KR); Chung Hee Lee, Daejeon (KR); Dong Hyeuk Park, Daejeon (KR)

(73) Assignee: LG Energy Solution, Ltd., Seoul (KR)

(21) Appl. No.: 17/922,858

(22) PCT Filed: Jul. 13, 2021
(86) PCT No.: PCT/KR2021/008980

§ 371 Date: Nov. 2, 2022

(30) Foreign Application Priority Data
Jul. 14, 2020 (KR) 10-2020-0087127
Jul. 7, 2021 (KR) 10-2021-0089217

(51) Int. Cl. B26F 1/14; B26F 1/12; H01M 4/04

(52) U.S. Cl. CPC B26F 1/14; B26F 1/12; H01M 4/04

(57) ABSTRACT

An electrode cutting device is provided. The electrode cutting device may perform a full-width cutting process and an edge cutting process together to simplify the manufacturing process, thereby significantly improving work efficiency. Particularly, an edge of the electrode is uniformly cut to prevent defects from occurring.

### CROSS-REFERENCE TO RELATED APPLICATION

The present application is a national stage entry under 35 U.S.C. §371 of International Application No. PCT/KR2021/008980 filed on Jul. 13, 2021 which claims priority from Korean Patent Application Nos. 10-2020-0087127, filed on Jul. 14, 2020, and 10-2021-0089217, filed on Jul. 07, 2021, which are hereby incorporated by reference in their entirety.

### TECHNICAL FIELD

The present invention relates to an electrode cutting device and method, which simplify a cutting process for an electrode sheet, and an electrode manufacturing apparatus comprising the same.

### BACKGROUND ART

In general, secondary batteries refer to chargeable and dischargeable batteries, unlike primary batteries that are not chargeable. Such a secondary battery is being widely used in the high-tech electronic fields such as mobile phones, notebook computers, and camcorders.

Such a secondary battery is classified into a can type secondary battery in which an electrode assembly is built in a metal can and a pouch type secondary battery in which an electrode assembly is built in a pouch. The pouch type secondary battery comprises an electrode assembly in which an electrode and a separator are alternately stacked, an electrolyte, and a pouch accommodating the electrode assembly and the electrolyte. Also, the pouch comprises an accommodation part accommodating the electrode assembly and an electrolyte and a sealing part sealing the accommodation part.

An electrode is manufactured by cutting an electrode sheet comprising a coating portion and a non-coating portion at regular intervals. That is, an electrode manufacturing method comprises a process of transferring an electrode sheet, a processing process of notching a non-coating portion of the transferred electrode sheet to process an electrode tab, a full-width cutting process of cutting the electrode sheet between the electrode tabs to manufacture in a full-width direction to manufacture the electrode, and an edge cutting process of slopingly cutting an edge of the electrode.

However, in the electrode manufacturing method, since the full-width cutting process and the edge cutting process are separately performed, it takes a lot of work time, and in particular, there is a problem in that the edge of the electrode is not cut a certain size during the edge cutting process.

### DISCLOSURE OF THE INVENTION

### Technical Problem

The present invention is invented to solve the above problems, and an object of the present invention is to provide an electrode cutting device and method, in which a full-width cutting process and an edge cutting process are performed together to simplify a process, thereby significantly improving work efficiency, and in particular, an edge of the electrode is uniformly cut to prevent defects from occurring, and an electrode manufacturing apparatus comprising the same.

### Technical Solution

An electrode cutting device according to the present invention for achieving the above object comprises: a die member on which an electrode sheet is disposed on a surface, on which a cutting line is partitioned; and a punch member configured to cut the electrode sheet disposed on the die member along the cutting line to manufacture an electrode, wherein the die member comprises: a disposition part which is provided at one side of the cutting line, on which the electrode sheet is disposed, and in which one end thereof disposed on the cutting line is formed as a disposition inclination surface to form a groove between the cutting line and the disposition inclination surface; a full-width cutting groove provided at the other side of the cutting line; and a V-shaped cutting groove provided on the cutting line and connected to the groove formed by the disposition inclination surface, wherein the punch member comprises: a full-width punch configured to cut the electrode sheet along the cutting line while being inserted into the full-width cutting groove, thereby manufacturing the electrode, wherein, since one end thereof corresponding to the disposition inclination surface is formed as a full-width inclination surface, an edge of the electrode disposed on the cutting line is cut to form an inclined surface; and a V-shaped punch configured to cut an edge of the electrode sheet disposed on the disposition inclination surface while being inserted into the V-shaped groove so as to form an inclined surface.

A reinforcing plate configured to improve strength and horizontality may be provided on a top surface of the disposition part.

The reinforcing plate may be coupled to a coupling groove formed in the disposition part, and a top surface of the reinforcing plate coupled to the coupling groove, an upper end surface of the full-width cutting groove, and an upper end surface of the V-shaped cutting groove may have the same height.

The electrode cutting device may further comprise a full-width support member configured to elastically support the electrode sheet disposed in the full-width cutting groove, wherein the full-width support member may comprise: a full-width support plate provided in the full-width cutting groove, provided to be movable in a direction of a bottom surface of the full-width cutting groove, and configured to elastically support the electrode sheet disposed in the full-width cutting groove; and a full-width elastic piece configured to provide elastic force to the full-width support plate so that the full-width support plate elastically supports the electrode sheet, wherein one end of the full-width support plate disposed on the cutting line is formed as the same inclined surface as the inclined surface of the full-width punch.

The electrode cutting device may further comprise a V-shaped support member configured to elastically support the electrode sheet disposed in the V-shaped cutting groove, wherein the V-shaped support member may comprise: a V-shaped support plate provided in the V-shaped cutting groove, provided to be movable in a direction of a bottom surface of the V-shaped cutting groove, and configured to elastically support the electrode sheet disposed in the V-shaped cutting groove; and a V-shaped elastic piece configured to provide elastic force to the V-shaped support plate so that the V-shaped support plate elastically supports the electrode sheet.

A cutting surface of the full-width punch configured to cut the electrode sheet and a cutting surface of the V-shaped punch may have different heights, and the cutting surface of the full-width punch may be provided to further protrude in a direction of the electrode sheet than the cutting surface of the V-shaped punch.

A full-width guide groove may be formed at one side of the full-width cutting groove, and a full-width guide protrusion movably inserted into the full-width guide groove may be formed on the full-width support plate.

A V-shaped guide groove may be formed at one side of the V-shaped cutting groove, and a V-shaped guide protrusion movably inserted into the V-shaped guide groove may be formed on the V-shaped support plate.

The electrode cutting device may further comprise a guide member configured to guide the punch member so as to descend or ascend vertically toward the die member.

The guide member may comprise: a lower guide plate on which the die member is installed; an upper guide plate on which the punch member is installed; and a guide rod provided on the lower guide plate and coupled to the upper guide plate to guide the upper guide plate so as to ascend or descend vertically toward the die member.

An electrode cutting method comprises: a disposition process of disposing an electrode sheet on a cutting line; and a punch process of cutting the electrode sheet along the cutting line to manufacture an electrode, wherein the punch process comprises a full-width cutting process of cutting an edge of one end of the electrode disposed on the cutting line together to form an inclined surface, and a V-shaped cutting process of cutting an edge of one end of the electrode sheet corresponding to the edge of the one end of the electrode to form an inclined surface.

The disposition process may comprise a first disposition process of disposing a portion of the electrode sheet, which is to be cut, on a cutting line that is partitioned between a disposition part and a full-width cutting groove and a second disposition process of disposing one end of the electrode sheet disposed on the cutting line in a V-shaped cutting groove of a die member, and in the punch process, a full-width punch of a punch member may be inserted into the full-width cutting groove to cut the electrode sheet along the cutting line, thereby manufacturing an electrode, wherein the punch process may comprise a full-width cutting process of cutting an edge of the electrode disposed on the cutting line together to form an inclined surface as an edge of the full-width punch disposed on the cutting line is formed as a full-width inclination surface, and a V-shaped cutting process of cutting an edge of the electrode sheet to form an inclined surface by inserting a V-shaped punch of the punch member into the V-shaped cutting groove.

In the first disposition process, a full-width support member may be provided in the full-width cutting groove to elastically support the electrode sheet disposed in the full-width cutting groove, and in the full-width cutting process, the full-width punch may cut the electrode sheet along the cutting line while being inserted into the full-width cutting groove in a state of pressing the electrode sheet disposed in the full-width cutting groove together with the full-width support member.

In the second disposition process, a V-shaped support member may be provided in the V-shaped cutting groove to elastically support the electrode sheet disposed in the V-shaped cutting groove, and in the V-shaped cutting process, the V-shaped punch may cut an edge of one end of the electrode sheet to form an inclined surface while being inserted into the V-shaped cutting groove in a state of pressing the electrode sheet disposed in the V-shaped cutting groove together with the V-shaped support member.

An electrode manufacturing apparatus according to the present invention comprises: a transfer device configured to transfer an electrode sheet, on which a non-coating portion is formed; a notching device configured to notch the non-coating portion of the electrode sheet transferred by the transfer device so as to process electrode tabs at regular intervals; and the electrode cutting device configured to cut the electrode sheet, on which the electrode tabs are processed by the notching device, so as to manufacture an electrode.

### Advantageous Effects

The electrode cutting device according to the present invention may comprise the disposition part, the die member comprising the full-width cutting groove and the V-shaped cutting groove, and the punch member comprising the full-width punch and the V-shaped punch. Therefore, the electrode sheet disposed on the die member may be cut in the full-width direction through the punch member, and also, the cut surface may be cut in the V shape, and as a result, the electrode having the inclined edge may be manufactured to simplify the processes, thereby improving the work efficiency. Particularly, the edge of the electrode may be uniformly cut to prevent the defects from occurring.

In addition, in the electrode cutting device according to the present invention, the die member may comprise the reinforcing plate, and thus, the electrode sheet may be stably disposed on the die member without being damaged.

In addition, in the electrode cutting device according to the present invention, the reinforcing plate may be coupled to the coupling groove formed in the disposition part. Thus, the top surface of the reinforcing plate coupled to the coupling groove, the upper end surface of the full-width cutting groove, and the upper end surface of the V-shaped cutting groove may have the same height to prevent the meandering defect of the electrode sheet from occurring, thereby improving the cutting accuracy of the electrode sheet.

In addition, in the electrode cutting device, the full-width support member may be disposed in the full-width cutting groove. Thus, the electrode sheet may be cut in the state in which the full-width punch and the full-width support member elastically press the electrode sheet, thereby improving the cutting accuracy of the electrode sheet.

In addition, in the electrode cutting device, the V-shaped support member may be disposed in the V-shape cutting groove. Thus, the end of the cut surface of the electrode sheet disposed on the die member may be cut in the state in which the V-shaped punch and the V-shaped support member elastically press the end of the cut surface of the electrode sheet, thereby improving the cutting accuracy when the edge of the electrode is cut.

### BRIEF DESCRIPTION OF THE DRAWINGS

FIG. 1 is a perspective view of an electrode cutting device according to a first embodiment of the present invention.

FIG. 2 is a perspective view illustrating a die member of the electrode cutting device according to a first embodiment of the present invention.

FIG. 3 is a plan view of FIG. 2,

FIG. 4 is a perspective view illustrating a punch member of the electrode cutting device according to a first embodiment of the present invention.

FIG. 5 is a bottom view of FIG. 4.

FIG. 6 is a cross-sectional view taken along line A-A of FIG. 1.

FIG. 7 is a cross-sectional view taken along line B-B of FIG. 1.

FIG. 8 is a flowchart illustrating an electrode cutting method according to the first embodiment of the present invention.

FIG. 9 is a plan view illustrating a disposition process in the electrode cutting method according to the first embodiment of the present invention.

FIG. 10 is a cross-sectional view illustrating a full-width cutting process in a punch process of the electrode cutting method according to the first embodiment of the present invention.

FIG. 11 is a plan view illustrating the electrode cut after the full-width cutting process.

FIG. 12 is a cross-sectional view illustrating a V-shaped cutting process in the punch process of the electrode cutting method according to the first embodiment of the present invention.

FIG. 13 is a plan view illustrating the electrode cut after the V-shaped cutting process.

FIG. 14 is a plan view illustrating an electrode manufacturing apparatus according to a second embodiment of the present invention.

### MODE FOR CARRYING OUT THE INVENTION

Hereinafter, embodiments of the present invention will be described in detail with reference to the accompanying drawings in such a manner that the technical idea of the present invention may easily be carried out by a person with ordinary skill in the art to which the invention pertains. The present invention may, however, be embodied in different forms and should not be construed as limited to the embodiments set forth herein. In the drawings, anything unnecessary for describing the present invention will be omitted for clarity, and also like reference numerals in the drawings denote like elements.

### Electrode Cutting Device According to First Embodiment of the Present Invention

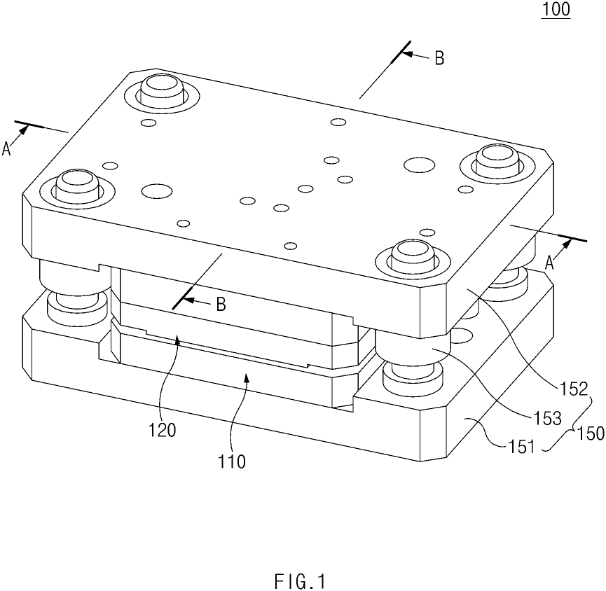

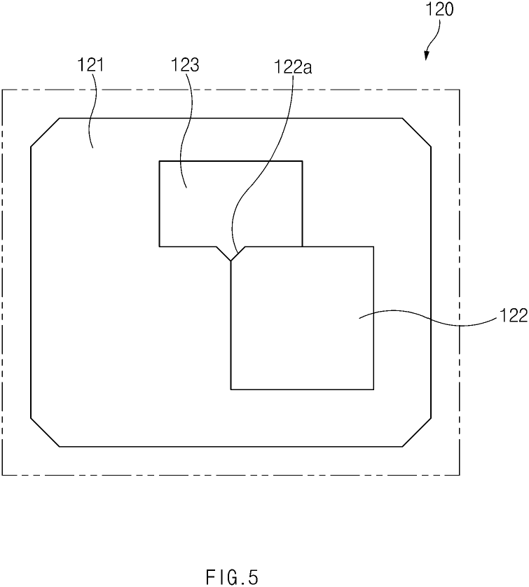

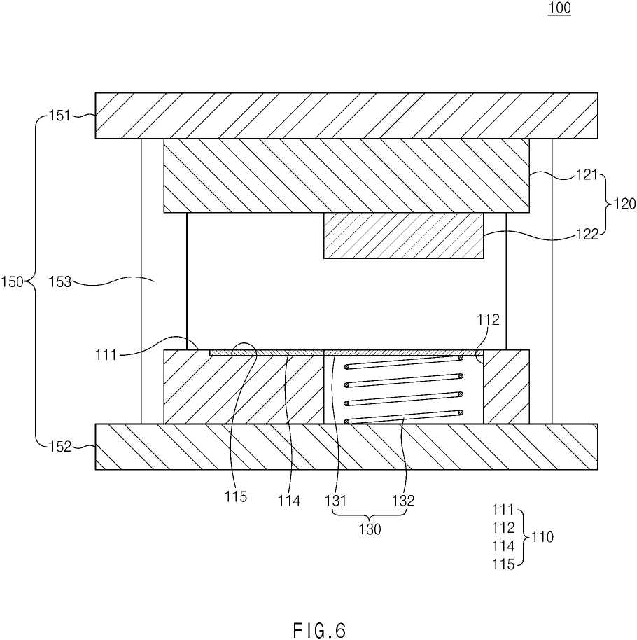

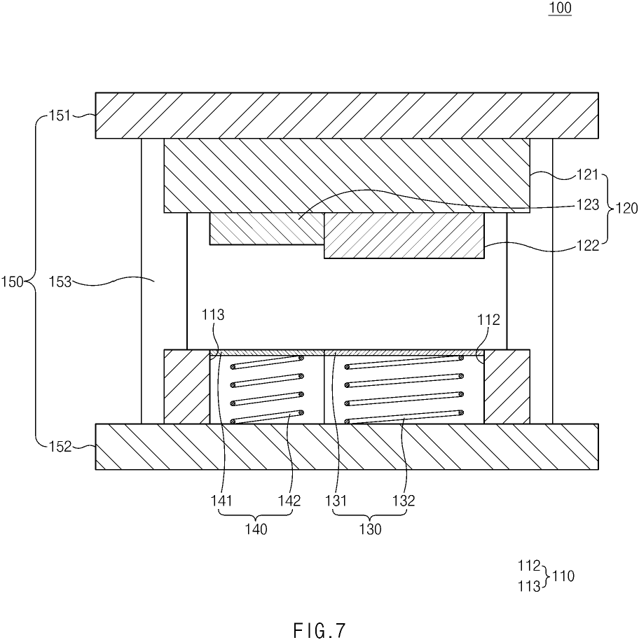

As illustrated in FIGS. 1 to 7 and 11, an electrode cutting device according to a first embodiment of the present invention comprises a die member 110, on which an electrode sheet 10 is disposed on a surface on which a cutting line is partitioned, and a punch member 120 that cuts the electrode 10 disposed on the die member along the cutting line to manufacture an electrode 10A.

The electrode sheet 10 comprises a coating portion provided with an electrode active material and an non-coating portion without the electrode active material, and the non-coating portion is processed into an electrode tab through a notching process.

In addition, the electrode sheet 10 on which the electrode tab is processed is transferred to the electrode cutting device according to the first embodiment of the present invention and then is cut into a certain size to be manufactured into the electrode 10A comprising the electrode tab and the coating portion.

### Die Member

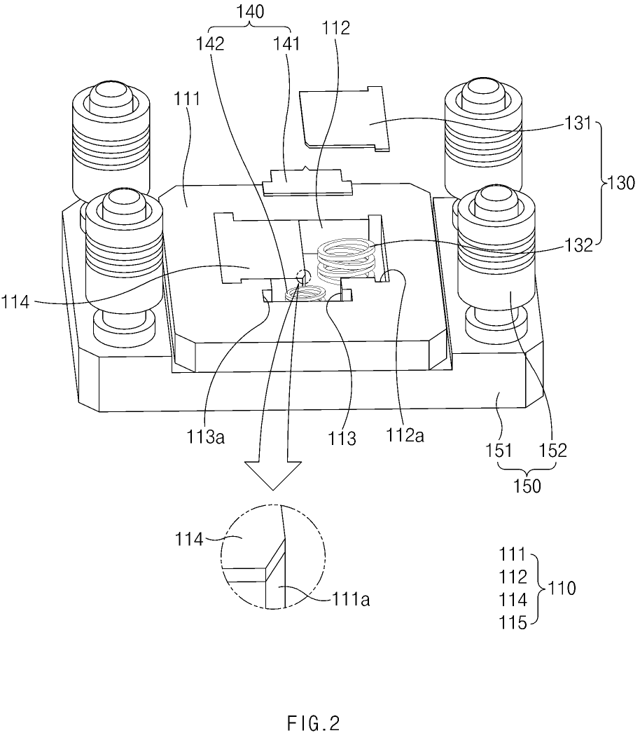

The electrode sheet is disposed on the die member 110. The die member 110 has a surface (a top surface when viewed in FIG. 2) that comprises a disposition part 111 provided at one side with respect to the cutting line, a full-width cutting groove 112 provided at the other side with respect to the cutting line, and a V-shaped cutting groove 113 provided on the cutting line.

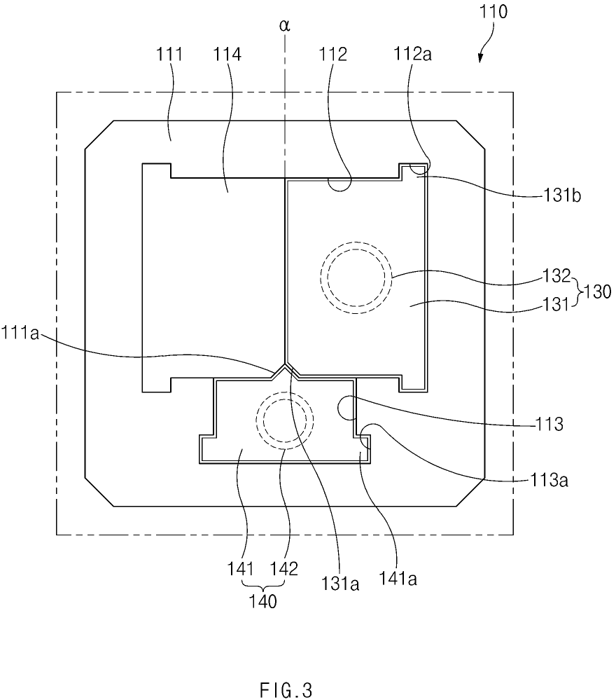

The disposition part 111 is provided at one side (a left side of the cutting line when viewed in FIG. 3) of the cutting line α that is partitioned on the top surface of the die member 110 and is provided as a horizontal surface so that the electrode sheet 10 is disposed.

Here, one end (a lower edge of the disposition part disposed on the cutting line when viewed in FIG. 3) of the disposition part 111 disposed on the cutting line α may have a disposition inclination surface 111a, and thus, a groove may be formed between the cutting line α and the disposition inclination surface 111a. A V-shaped punch may be inserted into the groove formed between the cutting line α and the disposition inclination surface 111a to cut an edge of the electrode sheet disposed on the cutting line so as to form an inclined surface.

The full-width cutting groove 112 is provided at the other side (a right side of the cutting line when viewed in FIG. 3) of the cutting line α partitioned on the die member 110 and is formed as a groove having a predetermined depth. That is, the electrode sheet disposed in the full-width cutting groove 112 is disposed in a levitated state. In addition, the electrode sheet 10 disposed in the full-width cutting groove 112 may be elastically supported by a full-width support member to be described later.

The V-shaped cutting groove 113 is provided in the cutting line α (a lower end of the cutting line at which the disposition part 111 and the full-width cutting groove 112 meet each other) and is formed as a groove having a predetermined depth. The V-shaped cutting groove 113 is provided to be connected to the groove formed in the disposition inclination surface 111a. That is, the electrode sheet 10 disposed in the V-shaped cutting groove 113 is disposed in a levitated state. In addition, the electrode sheet 10 disposed in the V-shaped cutting groove 113 may be elastically supported by a V-shaped support member to be described later.

The cutting line is partitioned in a full-width direction of the electrode sheet disposed on the die member.

### Punch Member

The punch member 120 is configured to manufacture the electrode by cutting the electrode sheet disposed on the die member along the cutting line, and comprises a punch body 121, a full-width punch 122, and a V-shaped punch 123.

The punch body 121 is provided above the die member 110 to descend or ascend toward the die member 110 as illustrated in FIG. 1.

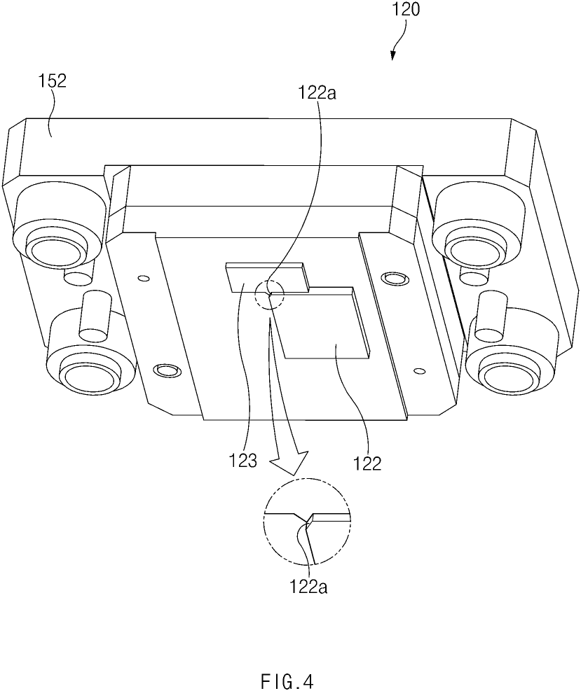

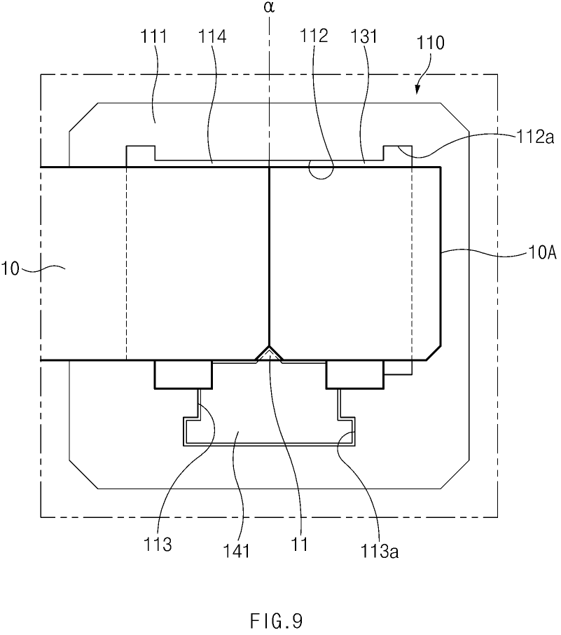

The full-width punch 122 is provided on a bottom surface of the punch body 121 as illustrated in FIG. 4 and is inserted into the full-width cutting groove 112 when the punch body 121 descends to cut the electrode sheet 10, which is disposed on the cutting line α, along the cutting line α, thereby manufacturing the electrode. That is, referring to FIG. 9, the full-width punch 122 cuts the electrode sheet disposed on the cutting line in the full-width direction of the electrode sheet to manufacture the electrode.

One end of the full-width punch 122, which corresponds to the disposition inclination surface 111a (a lower end of a left side of the full-width punch disposed on the cutting line when viewed in FIG. 3) may be formed as a full-width inclination surface 122a, and the full-width inclination surface 122a cuts an edge of the electrode 10A disposed on the cutting line to form an inclined surface.

That is, the full-width punch 122 cuts the electrode sheet disposed on the die member along the cutting line to manufacture the electrode, and simultaneously, cuts the edge of the electrode 10A disposed on the cutting line to form an inclined surface. In summary, the full-width punch 122 may cut the electrode sheet and the edge of the electrode at the same time, and as a result, the electrode 10A of which the edge is cut to form the inclined surface may be manufactured.

The V-shaped punch 123 is provided on the bottom surface of the punch body 121 and cuts the edge of the electrode sheet disposed in the groove formed by the disposition inclination surface 111a while being inserted into the V-shaped cutting groove 113 to form an inclined surface.

In the electrode cutting device, which has the above-described structure, according to the first embodiment of the present invention, when the punch member 120 descends toward the die member 110 after the electrode sheet 10 is disposed on the die member 110, while the full-width punch 122 of the punch member 120 is inserted into the full-width cutting groove 112, the electrode sheet is cut along the cutting line, and simultaneously, the edge of the electrode disposed on the cutting line is cut to form the inclined surface, and then, the V-shaped punch 123 of the punch member 120 cuts the edge of the electrode sheet disposed on the cutting line while being inserted into the V-shaped cutting groove 113.

Therefore, the electrode cutting device according to the first embodiment of the present invention may manufacture the electrode having the inclined edge through one cutting process, and thus, the cutting process may be simplified to improve work efficiency, and in particular, the cutting accuracy may be improved to prevent defects from occurring.

The electrode cutting device according to the first embodiment of the present invention may comprise a reinforcing plate 114 on a top surface of the disposition part 111. The reinforcing plate 114 has a flat top surface on which the electrode sheet is disposed and has strength greater than that of the disposition part. Thus, the disposition part may increase in horizontality. Particularly, the reinforcing plate 114 may be detachably coupled to the disposition part 111 to improve ease of maintenance. Particularly, since the reinforcing plate 114 has strength greater than that of the die member 110, the reinforcing plate 114, the reinforcing plate 114 may be prevented from being easily damaged by an external impact or a punching operation.

One end of the reinforcing plate 114 may be disposed to match the cutting line α, and thus, a cutting point and position of the electrode sheet may be more clearly identified.

The reinforcing plate 114 may be coupled to the disposition part 111 to slidably move in a direction toward or opposite to the cutting line α. Thus, when an end of the reinforcing plate 114 and the cutting line α do not match, the position of the reinforcing plate 114 may be adjusted to allow the end of the reinforcing plate 114 to match the cutting line α. Particularly, the position of the reinforcing plate 114 may be arbitrarily adjusted to change the position of the cutting line α.

The reinforcing plate 114 is coupled to the coupling groove 115 formed in the disposition part 111, in particular, a top surface of the reinforcing plate 114, an upper end surface of the full-width cutting groove 112, and an upper end surface of the V-shaped cutting groove 113 have the same height when viewed with respect to the electrode sheet. Thus, the horizontality of the electrode sheet 10 disposed on the die member may increase, and as a result, the cutting accuracy when punching the electrode sheet 10 may be improved.

The reinforcing plate 114 may be coupled to the coupling groove 115 so as to be adjustable in height in a direction of the bottom surface of the coupling groove 115 or in a direction opposite to the bottom surface of the coupling groove 115. Thus, the height of the reinforcing plate 114 may be adjusted to match the height of the upper end surface of the full-width cutting groove 112 and the upper end surface of the V-shaped cutting groove 113.

In the electrode cutting device according to the first embodiment of the present invention, a full-width support member 130 that elastically supports the electrode sheet disposed in the full-width cutting groove 112 is further disposed in the full-width support groove 112. Particularly, the full-width support member 130 serves to elastically press the electrode sheet together with the full-width punch when the full-width punch cuts the electrode sheet.

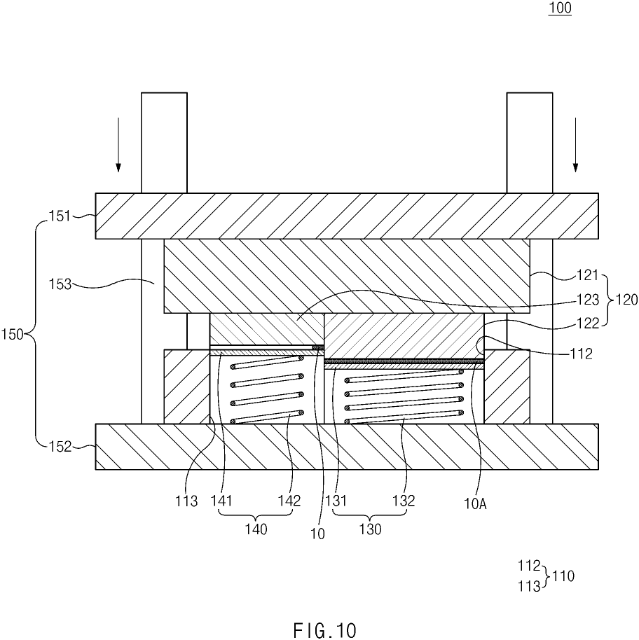

That is, the full-width support member 130 is provided to be movable in a direction of a bottom surface of the full-width cutting groove 112 (a downward direction of the full-width support member when viewed in FIG. 10) and comprises a full-width support plate 131 elastically supporting the electrode sheet 10 disposed in the full-width cutting groove 112 and a full-width elastic piece 132 providing elastic force so that the full-width support plate 131 is disposed on an upper end of the full-width cutting groove 112, and also, the full-width support plate elastically supports the electrode sheet 10.

Here, an end of the full-width support plate 131 disposed on the cutting line α has the same inclined surface 131a as the full-width inclination surface 122a of the full-width punch 122.

In the full-width support member 130 having the above-described configuration, the full-width punch 122 and the full-width support plate 131 may press both surfaces of the electrode sheet 10 at a potion at which the full-width punch 122 is in close contact with the electrode sheet 10 disposed in the full-width cutting groove 112, and in particular, the full-width punch 122 and the full-width support plate 131 elastically press the electrode sheet 10 by the full-width elastic piece 132 to prevent wrinkles from occurring when cutting the electrode sheet 10 disposed in the full-width cutting groove 112. In addition, the full-width punch 122 cuts the electrode sheet 10 disposed in the cutting groove 112 along the cutting line at a point at which the full-width punch 122 is inserted into the full-width cutting groove 112. Here, the full-width support plate 131 may elastically press the bottom surface of the electrode sheet 10 by the full-width elastic piece 132 to accurately cut the electrode sheet 10.

The full-width elastic piece may be provided as a coil spring.

In the electrode cutting device according to the first embodiment of the present invention, a V-shaped support member 140 that elastically supports the electrode sheet disposed in the V-shaped cutting groove 113 is further disposed in the V-shaped support groove 113.

The V-shaped support member 140 is provided to be movable in the direction of a bottom surface of the V-shaped cutting groove 113 (a downward direction of the V-shaped support member when viewed in FIG. 10) and comprises a V-shaped support plate 141 elastically supporting the electrode sheet 10 disposed in the V-shaped cutting groove 113 and a V-shaped elastic piece 142 providing elastic force so that the V-shaped support plate 141 is disposed on an upper end of the V-shaped cutting groove 113, and also, the V-shaped support plate elastically supports the electrode sheet 10.

In the V-shaped support member 140 having the above-described configuration, the V-shaped punch 123 and the V-shaped support plate 141 may press both surfaces of the electrode sheet 10 at a potion at which the V-shaped punch 123 is in close contact with the electrode sheet 10 disposed in the V-shaped cutting groove 113, and in particular, the V-shaped punch 123 and the V-shaped support plate 141 elastically press the electrode sheet 10 by the V-shaped elastic piece 142 to prevent wrinkles from occurring when cutting the electrode sheet 10 disposed in the V-shaped cutting groove 113. In addition, the V-shaped punch 123 cuts the electrode sheet 10 disposed in the cutting groove 113 along the cutting line at a point at which the V-shaped punch 123 is inserted into the V-shaped cutting groove 113. Here, the V-shaped support plate 141 may elastically press the bottom surface of the electrode sheet 10 by the V-shaped elastic piece 142 to accurately cut the electrode sheet 10.

The V-shaped elastic piece 142 may be provided as a coil spring.

In the electrode cutting device according to the first embodiment of the present invention, a cutting surface (a bottom surface of the full-width punch when viewed in FIG. 10) of the full-width punch 122, which cuts the electrode sheet 10 and a cutting surface (a bottom surface of the V-shaped punch when viewed in FIG. 10) of the V-shaped punch 123 have different heights when viewed with respect to the electrode sheet. In more detail, the cutting surface of the full-width punch 122 is provided to further protrude in the direction of the electrode sheet 10 than the cutting surface of the V-shaped punch 123. Thus, the electrode sheet 10 is cut along the cutting line to manufacture the electrode, and simultaneously, the edge of the electrode disposed on the cutting line is cut to form the inclined surface, and then the edge of the electrode sheet disposed on the cutting line is cut to form the inclined surface.

In the electrode cutting device according to the first embodiment of the present invention, a full-width guide groove 112a formed in a vertical direction is formed in the full-width cutting groove 112, and a full-width guide protrusion 131b movably inserted into in the full-width guide groove 112a in the vertical direction is formed on the full-width support plate 131. Thus, the full-width support plate 131 provided in the full-width guide groove 112a may vertically move to prevent the electrode sheet disposed on the full-width support plate 131 from moving.

In the electrode cutting device according to the first embodiment of the present invention, a V-shaped guide groove 113a formed in the vertical direction is formed in the V-shaped cutting groove 113, and a V-shaped guide protrusion 141a movably inserted into in the V-shaped guide groove 113A in the vertical direction is formed on the V-shaped support plate 141. Thus, the V-shaped support plate 141 provided in the V-shaped guide groove 113A may vertically move to prevent the electrode sheet disposed on the V-shaped support plate from moving.

The electrode cutting device according to the first embodiment of the present invention further comprises a guide member 150 that guides the punch member 120 to descend or ascend vertically toward the die member 110.

That is, the guide member 150 comprises a lower guide plate 151 on which the die member 110 is installed, an upper guide plate 152 on which the punch member 120 is installed, and a guide rod 153 having a lower end, which is provided on the lower guide plate 151 when viewed in FIG. 1, and an upper end, which is coupled so that the upper guide plate 152 descends or ascends vertically when viewed in FIG. 1.

The guide member 150 having the above-described configuration may allow the upper guide plate 152 to vertically move along the guide rod 153 and thus may guide the punch member 120 provided on the upper guide plate 152 to descend or ascend vertically toward the die member 110. Therefore, the electrode sheet may be cut vertically and thus be improved in cutting accuracy.

Therefore, the electrode cutting device according to the first embodiment of the present invention may manufacture the electrode by cutting the electrode sheet along the cutting line, and simultaneously, each of the edge of the electrode and the edge of the electrode sheet, which are disposed on the cutting line, may be cut to form the inclined surface, thereby simplifying the process, and in particular, reducing the time taken to manufacture the electrode having the inclined edge, particularly, reducing the defect rate.

Hereinafter, an electrode cutting method according to the first embodiment of the present invention will be described.

### Electrode Cutting Method According to First Embodiment of the Present Invention

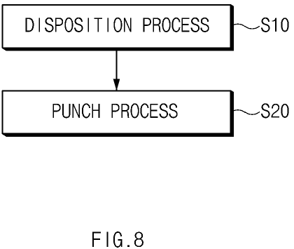

As illustrated in FIGS. 8 to 13, an electrode cutting method according to the first embodiment of the present invention comprises a disposition process of disposing an electrode sheet on a cutting line and a punch process of cutting the electrode sheet along the cutting line to manufacture an electrode, wherein an edge of one end of the electrode disposed on the cutting line is cut together to form an inclined surface, and then, an edge of one end of the electrode sheet, which corresponds to the edge of the one end of the electrode, is cut to form an inclined surface.

Here, the electrode cutting method according to the first embodiment of the present invention uses the electrode cutting device, which is described above, and the electrode cutting device comprises a die member and a punch member. Since the electrode cutting device has been described in detail above, a detailed description thereof will be omitted.

### Disposition Process

The disposition process (S10) comprises a first disposition process of disposing a portion of the electrode sheet 10, which is to be cut, on a cutting line α that is partitioned between a disposition part 111 and a full-width cutting groove 112 and a second disposition process of disposing a portion of the electrode sheet 10, which is to be cut, disposed on the cutting line in a V-shaped cutting groove 113 of the die member 110.

In the first disposition process, a full-width support member 130 is provided in the full-width cutting groove to elastically support the electrode sheet disposed in the full-width cutting groove.

In the second disposition process, a V-shaped support member 140 is provided in the V-shaped cutting groove 113 to elastically support the electrode sheet disposed in the V-shaped cutting groove 113.

### Punch Process

In the punch process (S20), a full-width punch of the punch member 120 is inserted into the full-width cutting groove 112 to cut the electrode sheet along the cutting line, thereby manufacturing an electrode, and the punch process (S20) comprises a full-width cutting process of cutting an edge of the electrode disposed on the cutting line together to form an inclined surface as an edge of the full-width punch disposed on the cutting line is formed as a full-width inclination surface 122a and a V-shaped cutting process of cutting an edge of the electrode sheet to form an inclined surface by inserting the V-shaped punch of the punch member 120 into the V-shaped cutting groove 113.

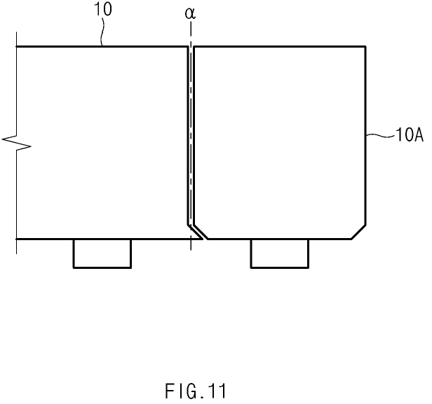

In the full-width cutting process, the full-width punch 122 of the punch member 120 is inserted into the full-width cutting groove 112 to cut the electrode sheet 10, which is disposed on the cutting line, along the cutting line, thereby manufacturing an electrode 10A. Here, as illustrated in FIG. 11, the full-width inclination surface 122a of the full-width punch cuts the edge of the electrode disposed on the cutting line to form the inclined surface.

In the full-width cutting process, the full-width punch cuts the electrode sheet while being inserted into the full-width cutting groove 112 in a state of pressing the electrode sheet disposed in the full-width cutting groove 112 together with the full-width support member 130.

Particularly, in the full-width cutting process, when cutting the electrode sheet 10, the full-width punch and the full-width support member 130 cut the electrode sheet 10 in a state of elastically pressing the electrode sheet 10 to prevent wrinkles from occurring in the electrode sheet 10, thereby improving the cutting accuracy of the electrode sheet.

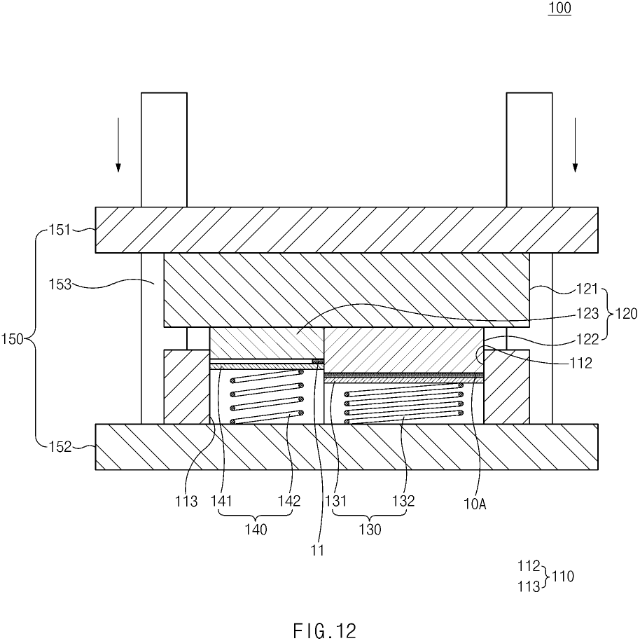

In the V-shaped cutting process, as illustrated in FIG. 12, the V-shaped punch 123 of the punch member 120 cuts the edge of the electrode sheet 10 disposed in the V-shaped groove to form the inclined surface while being inserted into the V-shaped cutting groove 113.

In the V-shaped cutting process, the V-shaped punch cuts the edge of the one end of the electrode sheet to form the inclined surface while being inserted into the V-shaped cutting groove 113 in the state of pressing the electrode sheet disposed in the V-shaped cutting groove 113 together with the V-shaped support member 140.

Particularly, in the V-shaped cutting process, when cutting the edge of the electrode sheet, the V-shaped punch 123 and the V-shaped support member 140 cut the edge of the electrode sheet in the state of elastically pressing the edge of the electrode sheet disposed on the cutting line to prevent the wrinkles from occurring, thereby improving the cutting accuracy of the electrode sheet.

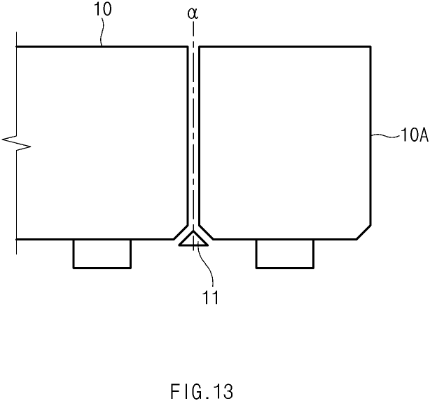

When the punch process is completed as described above, as illustrated in FIG. 13, the electrode sheet disposed on the cutting line α may be cut, and simultaneously, each of the edge of the one end of the electrode and the edge of the one end of the electrode sheet, which are disposed on the cutting line, may be cut to form the inclined plane. In addition, a triangular-shaped cutting piece 11 is generated.

Therefore, in the electrode cutting method according to the first embodiment of the present invention, the electrode having inclined edge may be continuously manufactured.

In this embodiment, the structure, in which only one edge of the electrode has the inclined surface when viewed in the full-length direction, has been described. However, each of both edges may have the inclined surface when viewed in the full-length direction according to the application.

Hereinafter, in descriptions of another embodiment of the present invention, constituents having the same function as the above-mentioned embodiment have been given the same reference numeral in the drawings, and thus duplicated description will be omitted.

### Electrode Manufacturing Apparatus According to Second Embodiment of the Present Invention

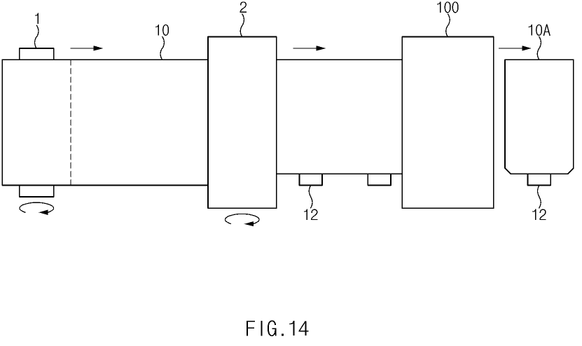

As illustrated in FIG. 14, an electrode manufacturing apparatus according to a second embodiment of the present invention comprises a transfer device 1 that transfers an electrode sheet 10, on which a non-coating portion 12 is formed, a notching device 2 that notches the non-coating portion of the electrode sheet 10 transferred by the transfer device 1 to process electrode tabs 12 at regular intervals, and an electrode cutting device 100 that cuts the electrode sheet, on which the electrode tab 12 is processed by the notching device 2, to manufacture an electrode 10A having an inclined edge.

Here, the electrode cutting device 100 comprises a die member 110 on which the electrode sheep, on which the electrode tab 12 is processed, is disposed, and a punch member 120 that cuts the electrode sheet 10 disposed on the die member 110 to manufacture the electrode 10A having the inclined edge.

The electrode cutting device 100 has the same configuration and function as the electrolyte cutting device according to the foregoing first embodiment, and thus, a duplicated description thereof will be omitted.

Therefore, the electrode manufacturing apparatus according to the second embodiment of the present invention may continuously manufacture the electrode 10A having the inclined edge, and in particular, may manufacture the electrode having the uniform quality, and in particular, may simplify the process.

Accordingly, the scope of the present invention is defined by the appended claims more than the foregoing description and the exemplary embodiments described therein. Various modifications made within the meaning of an equivalent of the claims of the invention and within the claims are to be regarded to be in the scope of the present invention.

Description of the Symbols

| | |
|---|---|
| 110: | Die member |
| 111: | Disposition part |
| 111a: | Disposition inclination surface |
| 112: | Full-width cutting groove |
| 112a: | Full-width guide groove |
| 113: | V-shaped cutting groove |
| 113a: | V-shaped guide groove |
| 114: | Reinforcing plate |
| 115: | Coupling groove |
| 120: | Punch member |
| 121: | Punch body |
| 122: | Full-width punch |
| 112a: | Full-width inclination surface |
| 123: | V-shaped punch |
| 130: | Full-width support member |
| 131: | Full-width support plate |
| 132: | Full-width elastic piece |
| 140:: | V-shaped support member |
| 141: | V-shaped support plate |
| 142: | V-shaped elastic piece |
| 150: | Guide member |
| 151: | Lower guide plate |
| 152: | Upper guide plate |
| 153: | Guide rod |

1. An electrode cutting device comprising:
a die member;
an electrode sheet is-configured to be disposed on a surface of the die member, wherein the electrode sheet includes a cutting line configured to be partitioned, wherein the die member comprises÷ a disposition part is-provided at one side of the cutting line, where the electrode sheet is disposed, wherein one end of the disposition part disposed on the cutting line is formed as a disposition inclination surface to form a groove between the cutting line and the disposition inclination surface÷ wherein the die member further comprises a full-width cutting groove provided at the other side of the cutting line; and a V-shaped cutting groove provided on the cutting line and connected to the groove formed by the disposition inclination surface; and,
a punch member configured to cut the electrode sheet disposed on the die member along the cutting line to manufacture an electrode, wherein the punch member comprises÷ a full-width punch configured to cut the electrode sheet along the cutting line while being inserted into the full-width cutting groove, thereby manufacturing the electrode, wherein, since one end thereof corresponding to the disposition inclination surface is formed as a full-width inclination surface, an edge of the electrode disposed on the cutting line is cut to form an inclined surface,and a V-shaped punch configured to cut an edge of the electrode sheet disposed on the disposition inclination surface while being inserted into the V-shaped groove so as to form an inclined surface.

2. The electrode cutting device of claim 1, wherein a reinforcing plate configured to improve strength and horizontality is provided on a top surface of the disposition part.

3. The electrode cutting device of claim 2, wherein the reinforcing plate is coupled to a coupling groove formed in the disposition part,
a top surface of the reinforcing plate coupled to the coupling groove, an upper end surface of the full-width cutting groove, and an upper end surface of the V-shaped cutting groove have the same height.

4. The electrode cutting device of claim 1, further comprising:
a full-width support member configured to elastically support the electrode sheet disposed in the full-width cutting groove,
wherein the full-width support member comprises:
a full-width support plate provided in the full-width cutting groove, the full-width support plate movable in a direction of a bottom surface of the full-width cutting groove, and configured to elastically support the electrode sheet disposed in the full-width cutting groove; and
a full-width elastic piece configured to provide elastic force to the full-width support plate so that the full-width support plate elastically supports the electrode sheet,
wherein one end of the full-width support plate disposed on the cutting line is formed as the same inclined surface as the inclined surface of the full-width punch.

5. The electrode cutting device of claim 1, further comprising:
a V-shaped support member configured to elastically support the electrode sheet disposed in the V-shaped cutting groove,
wherein the V-shaped support member comprises:
a V-shaped support plate provided in the V-shaped cutting groove, and movable in a direction of a bottom surface of the V-shaped cutting groove, and configured to elastically support the electrode sheet disposed in the V-shaped cutting groove; and
a V-shaped elastic piece configured to provide elastic force to the V-shaped support plate so that the V-shaped support plate elastically supports the electrode sheet.

6. The electrode cutting device of claim 1, wherein a cutting surface of the full-width punch is configured to cut the electrode sheet and a cutting surface of the V-shaped punch have different heights, and
the cutting surface of the full-width punch is provided to further protrude in a direction of the electrode sheet than the cutting surface of the V-shaped punch.

7. The electrode cutting device of claim 4, wherein a full-width guide groove is formed at one side of the full-width cutting groove, and
a full-width guide protrusion movably inserted into the full-width guide groove is formed on the full-width support plate.

8. The electrode cutting device of claim 5, wherein a V-shaped guide groove is formed at one side of the V-shaped cutting groove, and
a V-shaped guide protrusion movably inserted into the V-shaped guide groove is formed on the V-shaped support plate.

9. The electrode cutting device of claim 1, further comprising:
a guide member configured to guide the punch member so as to descend or ascend vertically toward the die member.

10. The electrode cutting device of claim 9, wherein the guide member comprises:
a lower guide plate on which the die member is installed;
an upper guide plate on which the punch member is installed; and
a guide rod provided on the lower guide plate and coupled to the upper guide plate to guide the upper guide plate so as to ascend or descend vertically toward the die member.

11. An electrode cutting method comprising:
disposing an electrode sheet on a cutting line; and
cutting the electrode sheet along the cutting line to manufacture an electrode, wherein the cutting of the electrode comprises cutting an edge of one end of the electrode disposed on the cutting line together to form an inclined surface, and cutting an edge of one end of the electrode sheet corresponding to the edge of the one end of the electrode to form an inclined surface.

12. The electrode cutting method of claim 11, wherein the disposing of the electrode comprises÷
disposing a portion of the electrode sheet, on a cutting line that is partitioned between a disposition part and a full-width cutting groove; and a
disposing one end of the electrode sheet disposed on the cutting line in a V-shaped cutting groove of a die member, and wherein the cutting of the electrode comprises
a full-width punch of a punch member is-inserted into the full-width cutting groove to cut the electrode sheet along the cutting line, to manufacture an electrode, wherein the cutting of the electrode comprises cutting an edge of the electrode disposed on the cutting line together to form an inclined surface so that an edge of the full-width punch disposed on the cutting line is formed as a full-width inclination surface, and cutting an edge of the electrode sheet to form an inclined surface by inserting a V-shaped punch of the punch member into the V-shaped cutting groove.

13. The electrode cutting method of claim 12, wherein the disposing of the portion of the electrode sheet comprises, a full-width support member is-provided in the full-width cutting groove to elastically support the electrode sheet disposed in the full-width cutting groove, and the cutting of the edge of the electrode comprises
the full-width punch cuts from the electrode sheet along the cutting line while being inserted into the full-width cutting groove in a state of pressing the electrode sheet disposed in the full-width cutting groove together with the full-width support member.

14. The electrode cutting method of claim 12, wherein, disposing of the one end of the electrode sheet comprises; a V-shaped support member is-provided in the V-shaped cutting groove to elastically support the electrode sheet disposed in the V-shaped cutting groove,
wherein the cutting of the edge of the electrode sheet comprises process, the V-shaped punch cuts from an edge of one end of the electrode sheet to form an inclined surface while being inserted into the V-shaped cutting groove in a state of pressing the electrode sheet disposed in the V-shaped cutting groove together with the V-shaped support member.

15. An electrode manufacturing apparatus comprising:
a transfer device configured to transfer an electrode sheet, having a non-coating portion formed thereon;
a notching device configured to notch the non-coating portion of the electrode sheet transferred by the transfer device so as to process electrode tabs at regular intervals; and
the electrode cutting device of claim 1configured to cut the electrode sheet, on which the electrode tabs are processed by the notching device, so as to manufacture an electrode.
